(19) United States
(12) Patent Application Publication
(10) Pub. No.: US 2023/0304650 A1
(43) Pub. Date: Sep. 28, 2023

(54) FOLDING LAMP

(71) Applicant: NINGBO JINGHUI OPTO-ELECTRONIC CO., LTD., Zhejiang Province (CN)

(72) Inventors: Guohui Bai, Zhejiang Province (CN); Xia Xiao, Zhejiang Province (CN); Guohuan Feng, Zhejiang Province (CN)

(21) Appl. No.: 17/843,598

(22) Filed: Jun. 17, 2022

(30) Foreign Application Priority Data
Mar. 25, 2022 (CN) 202220673171.0

(51) Int. Cl. F21V 21/26; F21V 17/02

(52) U.S. Cl. CPC F21V 21/26; F21V 17/02

(57) ABSTRACT

The invention discloses a folding lamp, including a main body and light-emitting lamp bodies. The main body is provided with a plurality of first rotational connecting portions around a central axis thereof. The light-emitting lamp body is provided with a second rotational connecting portion. The light-emitting lamp body is arranged rotationally on the main body by means of mating of the second rotational connecting portion and first rotational connecting portion such that the light-emitting lamp body is endowed with a rotationally unfolded state and a folded state. When the light-emitting lamp body is in the folded state, a first outgoing surface in the light-emitting lamp body faces an outer side, and an end face of the light-emitting lamp body facing the outer side is a plane. According to the invention, the folding lamp may implement flat light emission in the unfolded state and omnidirectional light emission in the folded state.

### TECHNICAL FIELD

The invention herein relates to the field of lighting equipment, and particularly to a folding lamp.

### BACKGROUND ART

Lighting lamp has become an indispensable tool in daily life. Users have different requirements for illumination modes in different usage environments. However, a lamp in the prior art is undiversified in function, and may provide only one illumination mode. For example, a panel lamp provides a flat light-emitting mode, and a bulb lamp provides an omnidirectional light-emitting mode. Different lamps are needed to meet user requirements, and this brings inconvenience. In addition, the bulb lamp is usually shaped like a ball that cannot be placed stably, and thus is likely to rotate on a table to fall onto the ground and finally be damaged.

### SUMMARY OF THE INVENTION

In order to overcome the shortcomings in the prior art, the invention provides a folding lamp. A light-emitting lamp body of the folding lamp is mounted to a main body rotationally so as to endow the folding lamp with an unfolded state and a folded state, and the folding lamp may implement flat light emission in the unfolded state and omnidirectional light emission in the folded state. Therefore, a user may switch the state of the folding lamp conveniently according to an own requirement in use.

In order to achieve the above objective, the invention is implemented by the following technical solution.

A folding lamp includes a main body and a plurality of light-emitting lamp bodies. The main body is provided with a plurality of first rotational connecting portions around a central axis thereof. The light-emitting lamp body is provided with a second rotational connecting portion matched with the first rotational connecting portion. The light-emitting lamp body is arranged rotationally on the main body by means of mating of the second rotational connecting portion and the corresponding first rotational connecting portion such that the light-emitting lamp body is endowed with a rotationally unfolded state and a folded state relative to the main body.

When the light-emitting lamp body is in the folded state, a first outgoing surface of a first light-emitting portion in the light-emitting lamp body faces an outer side, and an end face of the light-emitting lamp body facing the outer side is a plane.

When the light-emitting lamp body is in the rotationally unfolded state, the first outgoing surfaces of the first light-emitting portions in the light-emitting lamp bodies are parallel or coplanar.

With the adoption of the above structure, a user may operate the light-emitting lamp body to rotate relative to the main body, thereby switching the light-emitting lamp body between the rotationally unfolded state and the folded state.

When the light-emitting lamp body is in the rotationally unfolded state, the first outgoing surfaces of the plurality of light-emitting lamp bodies may implement flat light emission of the folding lamp.

When the light-emitting lamp body is in the folded state, the first outgoing surfaces of the plurality of light-emitting lamp bodies may implement omnidirectional light emission of the folding lamp.

In the above structure, when the light-emitting lamp body is in the folded state, the end face of the light-emitting lamp body facing the outer side is a plane, so that the light-emitting lamp body may be placed more stably, and is unlikely to rotate on a table to fall onto the ground from the table and finally be damaged.

When the light-emitting lamp body emits light in the folded state, the folding lamp is shaped like a storm lantern structure with an outer polygonal cover, and is more attractive in appearance.

Further, in a direction of a rotating shaft of the light-emitting lamp body, the first rotational connecting portion includes rotating protrusions arranged at two sides of the second rotational connecting portion. The rotating protrusion is provided with a first rotational mating hole. The second rotational connecting portion is provided with a second rotational mating hole. The second rotational mating hole is formed coaxial with the first rotational mating hole.

With the adoption of the above structure, a rotating shaft pin penetrates through the first rotational mating hole of the rotating protrusion and the second rotational mating hole in the second rotational connecting portion so as to connect the light-emitting lamp body to the main body rotationally. Specifically, the first rotational connecting portion is in damped rotational mating with the second rotational connecting portion, so that the light-emitting lamp body may stop at any angle to achieve the applicability of the folding lamp to a larger range and more environments.

Further, the main body includes a base, a top cover, and a connecting pillar configured to connect the base with the top cover. The plurality of first rotational connecting portions are arranged around the top cover. The light-emitting lamp bodies are arranged around the top cover, and are provided with the second rotational connecting portions at ends facing the top cover.

Further, the main body is provided with a second light-emitting portion on an end face that the central axis of the main body penetrates through, and a second outgoing surface of the second light-emitting portion faces the outer side.

With the adoption of the above structure, the light-emitting lamp bodies are arranged around the second light-emitting portion. When the light-emitting lamp body is in the rotationally unfolded state, the first light-emitting portion in the light-emitting lamp body emits light together with the second light-emitting portion of the main body, so that the folding lamp may implement flat light emission more uniformly to illuminate a large range. When the light-emitting lamp body is in the folded state, the arrangement of the second light-emitting portion endows the folding lamp with more outgoing surfaces, so that the folding lamp may illuminate more directions.

Specifically, the second light-emitting portion is arranged on the top cover, and the second outgoing surface is arranged on an end face of the top cover back to the base. The second light-emitting portion includes a second lamp panel with a plurality of second LED lamps, the second lamp panel is arranged in the top cover, and a side of the second lamp panel where the second LED lamps are arranged faces the second outgoing surface.

Further, a plurality of second outgoing surfaces are arranged around the central axis of the main body on a plane where the second outgoing surface is located.

Further, the second outgoing surfaces are matched in number and in one-to-one correspondence with the light-emitting lamp bodies. When the light-emitting lamp body is in the rotationally unfolded state, a connecting line of a single light-emitting lamp body and the corresponding second outgoing surface passes through the central axis of the main body.

With the adoption of the above structure, the folding lamp may implement flat light emission more uniformly when the light-emitting lamp body is in the rotationally unfolded state.

Further, the first light-emitting portion includes a first lamp panel, a mounting portion, and a light-transmitting plate capable of transmitting light. The mounting portion is provided with a mounting groove. The light-transmitting plate is matched with an opening of the mounting groove. A first LED lamp is arranged on the first lamp panel in a space enclosed by the mounting groove and the light-transmitting plate. A side of the first lamp panel where the first LED lamp is arranged faces the light-transmitting plate.

Specifically, a bayonet is formed in a sidewall of the mounting groove, and a buckle matched with the bayonet is arranged on the light-transmitting plate. A first penetration hole is formed in an end of a bottom surface of the mounting groove away from the bayonet. A fixed pillar matched with the first penetration hole is arranged at an end of the light-transmitting plate away from the buckle. During mounting, the buckle of the light-transmitting plate is clamped into the bayonet of the mounting groove, then the end of the light-transmitting plate away from the buckle is pressed down to make the fixed pillar opposite to the first penetration hole, and a screw penetrates through the first penetration hole to be connected with the fixed pillar so as to implement fixed connection between the light-transmitting plate and the mounting groove. More specifically, a second penetration hole matched with the first penetration hole is formed in the first lamp panel, and the screw penetrates through the first penetration hole and the second penetration hole to be connected with the fixed pillar.

Further, the first light-emitting portion is arranged at a middle position of the light-emitting lamp body, and the light-emitting lamp body is provided with a plurality of through holes around the first light-emitting portion.

With the adoption of the above structure, the formation of the through hole is conducive to heat dissipation of the first light-emitting portion in the light-emitting lamp body, particularly when the light-emitting lamp body is in the folded state.

Specifically, the through hole is long-strip and inclined, and the through holes are parallel to one another.

Further, the main body includes a connecting piece configured to obtain electric energy and a power module connected with the connecting piece. The main body is provided with a first wire hole at a position where the first rotational connecting portion is arranged. The light-emitting lamp body is provided with a second wire hole at a position where the second rotational connecting portion is arranged. A wire passes through the first wire hole and the second wire hole to connect the power module with the first light-emitting portion of the light-emitting lamp body. The second light-emitting portion on the main body is connected with the power module.

With the adoption of the above structure, the power module is configured to convert a voltage into a working voltage of the first light-emitting portion and the second light-emitting portion. The formation of the first wire hole and the second wire hole facilitates wiring of the whole folding lamp.

Specifically, the connecting piece is a threaded connector that may be connected with an external socket. The connecting piece is arranged at a side of the base back to the top cover. The power module is arranged in the base. The power module guides the wire into the top cover through the connecting pillar to be connected with the second light-emitting portion, or further guides the wire from the top cover into the light-emitting lamp body to be connected with the first light-emitting portion.

Further, four light-emitting lamp bodies are arranged.

When the light-emitting lamp body is in the folded state, end faces of two adjacent light-emitting lamp bodies facing the outer side are perpendicular to each other.

With the adoption of the above structure, when the light-emitting lamp body is in the folded state, the whole folding lamp is square, attractive in appearance, and practical.

Further, a detection module is arranged on the main body. The detection module is configured to detect whether any person is in a detection region thereof, and send a detection signal to control a working state of the first light-emitting portion in the light-emitting lamp body and a working state of the second light-emitting portion in the main body.

With the adoption of the above structure, the detection module, when detecting that a person is in the detection region, sends a corresponding detection signal to control the first light-emitting portion in the light-emitting lamp body and the second light-emitting portion in the main body to emit light. The detection module, when detecting that no person is in the detection region, sends a corresponding detection signal to control the first light-emitting portion in the light-emitting lamp body and the second light-emitting portion in the main body not to emit light.

Specifically, a control unit is arranged in the power module. The control unit is connected with the detection module so as to receive the detection signal sent thereby. The control unit is connected with the first light-emitting portion and the second light-emitting portion respectively so as to control the working states of the first light-emitting portion and the second light-emitting portion according to the detection signal of the detection module. Specifically, the detection module is an infrared detection module. The detection module is arranged at a central position of the top cover.

Compared with the prior art, the invention has the following beneficial effects.
(1) The light-emitting lamp body of the folding lamp of the invention is mounted to the main body rotationally so as to endow the folding lamp with the unfolded state and the folded state, and the folding lamp may implement flat light emission in the unfolded state and omnidirectional light emission in the folded state. Therefore, the user may switch the state of the folding lamp conveniently according to an own requirement in use.
(2) According to the folding lamp of the invention, in the folded state, the end face of the light-emitting lamp body facing the outer side is a plane, so that the light-emitting lamp body may be placed more stably in the folded state, and is unlikely to rotate on a table to fall onto the ground from the table and finally be damaged. In the folded state, the folding lamp is shaped like a storm lantern structure with an outer polygonal cover, and is more attractive in appearance.
(3) According to the folding lamp of the invention, the formation of the first wire hole and the second wire hole facilitates wiring of the folding lamp.

### BRIEF DESCRIPTION OF THE DRAWINGS

FIG. 1 is a schematic structural diagram of a folding lamp in a folded state according to the invention.

FIG. 2 is a schematic structural diagram of a folding lamp in an unfolded state according to the invention.

FIG. 3 is a schematic structural diagram of rotational mating between a main body and light-emitting lamp body in a folding lamp according to the invention.

FIG. 4 is an enlarged diagram of part A in FIG. 3.

FIG. 5 is a schematic exploded structural diagram of a light-emitting lamp body in a folding lamp according to the invention.

FIG. 6 is a schematic exploded structural diagram of a main body in a folding lamp according to the invention.

Reference numerals: 1—main body; 101—first rotational connecting portion; 1011—rotating protrusion; 1011a—first rotational mating hole; 102—base; 103—top cover; 104—connecting pillar; 105—second light-emitting portion; 1051—second outgoing surface; 1052—second lamp panel; 1052a—second LED lamp; 106—connecting piece; 107—power module; 108—first wire hole; 109—detection module; 2—light-emitting lamp body; 201—second rotational connecting portion; 2011—second rotational mating hole; 202—first light-emitting portion; 2021—first outgoing surface; 2022—first lamp panel; 2022a—first LED lamp; 2022b—second penetration hole; 2023—mounting portion; 2023a—mounting groove; 2023a1—bayonet; 2023a2—first penetration hole; 2024—light-transmitting plate; 2024a—buckle; 2024b—fixed pillar; 203—through hole; and 204—second wire hole.

### DETAILED DESCRIPTION OF THE INVENTION

Specific implementation modes of the invention will further be described below in combination with the drawings and embodiments in detail. The following embodiments are used to describe the invention rather than limit the scope of the invention.

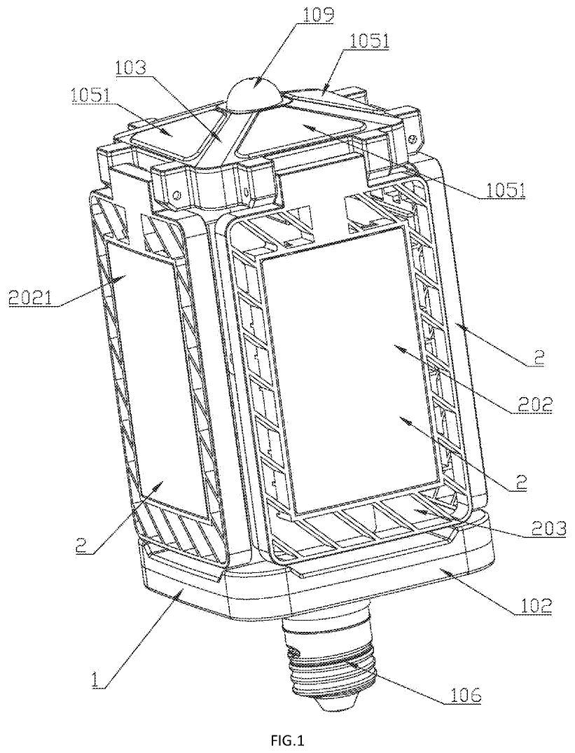

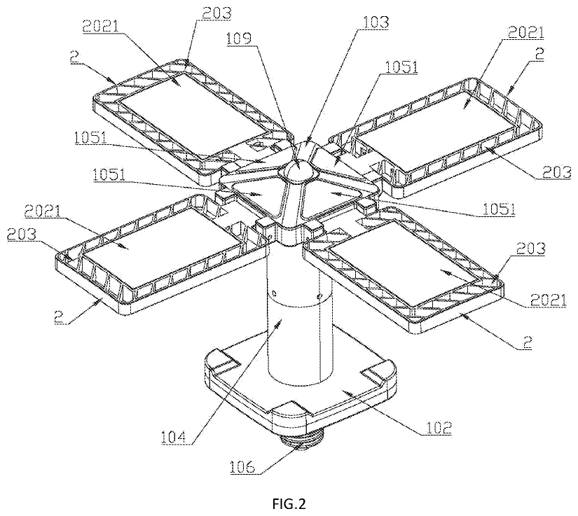

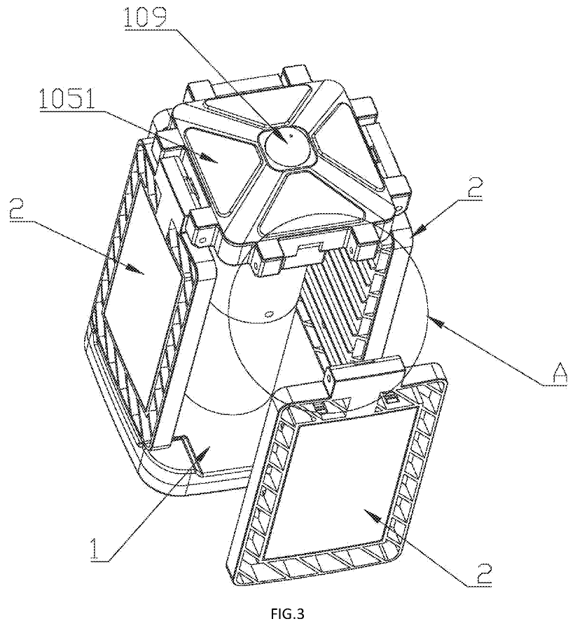

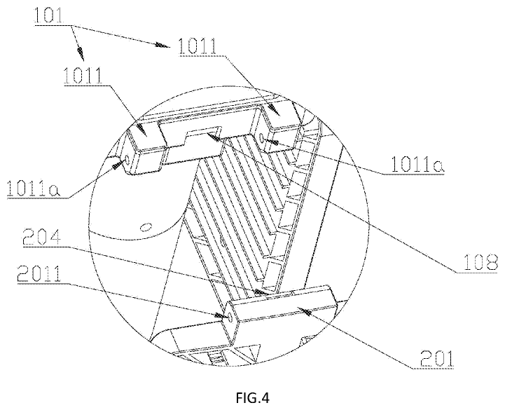

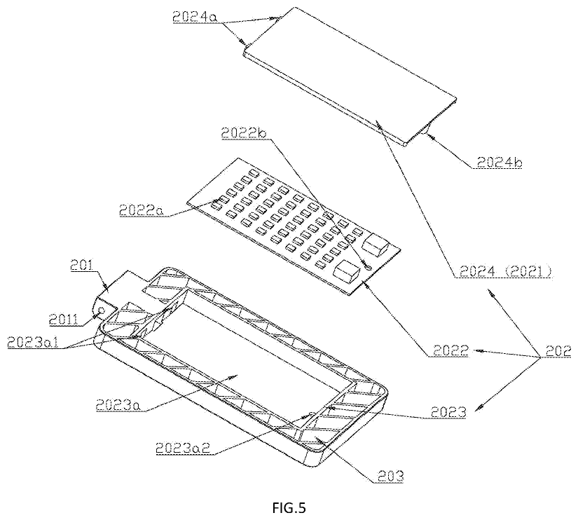

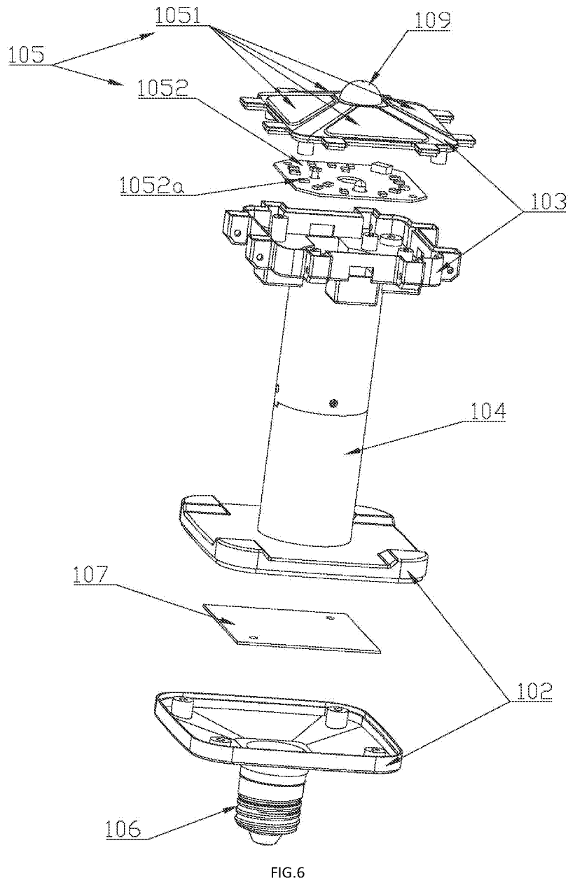

As shown in FIGS. 1 to 6, a folding lamp includes a main body 1 and a plurality of light-emitting lamp bodies 2. The main body 1 is provided with a plurality of first rotational connecting portions 101 around a central axis thereof. The light-emitting lamp body 2 is provided with a second rotational connecting portion 201 matched with the first rotational connecting portion 101. The light-emitting lamp body 2 is arranged rotationally on the main body 1 by means of mating of the second rotational connecting portion 201 and the corresponding first rotational connecting portion 101 such that the light-emitting lamp body 2 is endowed with a rotationally unfolded state and a folded state relative to the main body 1.

When the light-emitting lamp body 2 is in the folded state, a first outgoing surface 2021 of a first light-emitting portion 202 in the light-emitting lamp body 2 faces an outer side, and an end face of the light-emitting lamp body 2 facing the outer side is a plane.

When the light-emitting lamp body 2 is in the rotationally unfolded state, the first outgoing surfaces 2021 of the first light-emitting portions 202 in the light-emitting lamp bodies 2 are parallel or coplanar.

With the adoption of the above structure, a user may operate the light-emitting lamp body 2 to rotate relative to the main body 1, thereby switching the light-emitting lamp body 2 between the rotationally unfolded state and the folded state.

When the light-emitting lamp body 2 is in the rotationally unfolded state, the first outgoing surfaces 2021 of the plurality of light-emitting lamp bodies 2 may implement flat light emission of the folding lamp.

When the light-emitting lamp body 2 is in the folded state, the first outgoing surfaces 2021 of the plurality of light-emitting lamp bodies 2 may implement omnidirectional light emission of the folding lamp.

In the above structure, when the light-emitting lamp body 2 is in the folded state, the end face of the light-emitting lamp body 2 facing the outer side is a plane, so that the light-emitting lamp body may be placed more stably, and is unlikely to rotate on a table to fall onto the ground from the table and finally be damaged.

When the light-emitting lamp body 2 emits light in the folded state, the folding lamp is shaped like a storm lantern structure with an outer polygonal cover, and is more attractive in appearance.

Preferably, in a direction of a rotating shaft of the light-emitting lamp body 2, the first rotational connecting portion 101 includes rotating protrusions 1011 arranged at two sides of the second rotational connecting portion 201. The rotating protrusion 1011 is provided with a first rotational mating hole 1011a. The second rotational connecting portion 201 is provided with a second rotational mating hole 2011. The second rotational mating hole 2011 is formed coaxial with the first rotational mating hole 1011a.

With the adoption of the above structure, a rotating shaft pin penetrates through the first rotational mating hole 1011a of the rotating protrusion 1011 and the second rotational mating hole 2011 in the second rotational connecting portion 201 so as to connect the light-emitting lamp body 2 to the main body 1 rotationally. Specifically, the first rotational connecting portion 101 is in damped rotational mating with the second rotational connecting portion 201, so that the light-emitting lamp body 2 may stop at any angle to achieve the applicability of the folding lamp to a larger range and more environments.

Preferably, the main body 1 includes a base 102, a top cover 103, and a connecting pillar 104 configured to connect the base 102 with the top cover 103. The plurality of first rotational connecting portions 101 are arranged around the top cover 103. The light-emitting lamp bodies 2 are arranged around the top cover 103, and are provided with the second rotational connecting portions 201 at ends facing the top cover 103.

Preferably, the main body 1 is provided with a second light-emitting portion 105 on an end face that the central axis of the main body penetrates through, and a second outgoing surface 1051 of the second light-emitting portion 105 faces the outer side.

With the adoption of the above structure, the light-emitting lamp bodies 2 are arranged around the second light-emitting portion 105. When the light-emitting lamp body 2 is in the rotationally unfolded state, the first light-emitting portion 202 in the light-emitting lamp body 2 emits light together with the second light-emitting portion 105 of the main body 1, so that the folding lamp may implement flat light emission more uniformly to illuminate a large range. When the light-emitting lamp body 2 is in the folded state, the arrangement of the second light-emitting portion 105 endows the folding lamp with more outgoing surfaces, so that the folding lamp may illuminate more directions.

Specifically, the second light-emitting portion 105 is arranged on the top cover 103, and the second outgoing surface 1051 is arranged on an end face of the top cover 103 back to the base. The second light-emitting portion 105 includes a second lamp panel 1052 with a plurality of second LED lamps 1052a, the second lamp panel 1052 is arranged in the top cover 103, and a side of the second lamp panel 1052 where the second LED lamps 1052a are arranged faces the second outgoing surface.

Preferably, a plurality of second outgoing surfaces 1051 are arranged around the central axis of the main body 1 on a plane where the second outgoing surface 1051 is located.

Preferably, the second outgoing surfaces 1051 are matched in number and in one-to-one correspondence with the light-emitting lamp bodies 2. When the light-emitting lamp body 2 is in the rotationally unfolded state, a connecting line of a single light-emitting lamp body 2 and the corresponding second outgoing surface 1051 passes through the central axis of the main body 1.

With the adoption of the above structure, the folding lamp may implement flat light emission more uniformly when the light-emitting lamp body 2 is in the rotationally unfolded state.

Preferably, the first light-emitting portion 202 includes a first lamp panel 2022, a mounting portion 2023, and a light-transmitting plate 2024 capable of transmitting light. The mounting portion 2023 is provided with a mounting groove 2023a. The light-transmitting plate 2024 is matched with an opening of the mounting groove 2023a. A first LED lamp 2022a is arranged on the first lamp panel 2022 in a space enclosed by the mounting groove 2023a and the light-transmitting plate 2024. A side of the first lamp panel 2022 where the first LED lamp 2022a is arranged faces the light-transmitting plate 2024.

Specifically, a bayonet 2023a1 is formed in a sidewall of the mounting groove 2023a, and a buckle 2024a matched with the bayonet 2023a1 is arranged on the light-transmitting plate 2024. A first penetration hole 2023a2 is formed in an end of a bottom surface of the mounting groove 2023a away from the bayonet 2023a1. A fixed pillar 2024b matched with the first penetration hole 2023a2 is arranged at an end of the light-transmitting plate 2024 away from the buckle 2024a. During mounting, the buckle 2024a of the light-transmitting plate 2024 is clamped into the buckle 2024a of the mounting groove 2023a, then the end of the light-transmitting plate 2024 away from the buckle 2024a is pressed down to make the fixed pillar 2024b opposite to the first penetration hole 2023a2, and a screw penetrates through the first penetration hole 2023a2 to be connected with the fixed pillar 2024b so as to implement fixed connection between the light-transmitting plate 2024 and the mounting groove 2023a. More specifically, a second penetration hole 2022b matched with the first penetration hole 2023a2 is formed in the first lamp panel 2022, and the screw penetrates through the first penetration hole 2023a2 and the second penetration hole 2022b to be connected with the fixed pillar 2024b.

Preferably, the first light-emitting portion 202 is arranged at a middle position of the light-emitting lamp body 2, and the light-emitting lamp body 2 is provided with a plurality of through holes 203 around the first light-emitting portion 202.

With the adoption of the above structure, the formation of the through hole 203 is conducive to heat dissipation of the first light-emitting portion 202 in the light-emitting lamp body 2, particularly when the light-emitting lamp body 2 is in the folded state.

Specifically, the through hole 203 is long-strip and inclined, and the through holes 203 are parallel to one another.

Preferably, the main body 1 includes a connecting piece 106 configured to obtain electric energy and a power module 107 connected with the connecting piece 106. The main body 1 is provided with a first wire hole 108 at a position where the first rotational connecting portion 101 is arranged. The light-emitting lamp body 2 is provided with a second wire hole 204 at a position where the second rotational connecting portion 201 is arranged. A wire passes through the first wire hole 108 and the second wire hole 204 to connect the power module 107 with the first light-emitting portion 202 of the light-emitting lamp body 2. The second light-emitting portion 105 on the main body 1 is connected with the power module 107.

With the adoption of the above structure, the power module 107 is configured to convert a voltage into a working voltage of the first light-emitting portion 202 and the second light-emitting portion 105. The formation of the first wire hole 108 and the second wire hole 204 facilitates wiring of the whole folding lamp.

Specifically, the connecting piece 106 is a threaded connector that may be connected with an external socket. The connecting piece 106 is arranged at a side of the base 102 back to the top cover 103. The power module 107 is arranged in the base 102. The power module 107 guides the wire into the top cover 103 through the connecting pillar 104 to be connected with the second light-emitting portion 105, or further guides the wire from the top cover 103 into the light-emitting lamp body 2 to be connected with the first light-emitting portion 202.

Preferably, four light-emitting lamp bodies 2 are arranged.

When the light-emitting lamp body 2 is in the folded state, end faces of two adjacent light-emitting lamp bodies 2 facing the outer side are perpendicular to each other.

With the adoption of the above structure, when the light-emitting lamp body 2 is in the folded state, the whole folding lamp is square, attractive in appearance, and practical.

Preferably, a detection module 109 is arranged on the main body 1. The detection module 109 is configured to detect whether any person is in a detection region thereof, and send a detection signal to control a working state of the first light-emitting portion 202 in the light-emitting lamp body 2 and a working state of the second light-emitting portion 105 in the main body 1.

With the adoption of the above structure, the detection module 109, when detecting that a person is in the detection region, sends a corresponding detection signal to control the first light-emitting portion 202 in the light-emitting lamp body 2 and the second light-emitting portion 105 in the main body 1 to emit light. The detection module 109, when detecting that no person is in the detection region, sends a corresponding detection signal to control the first light-emitting portion 202 in the light-emitting lamp body 2 and the second light-emitting portion 105 in the main body 1 not to emit light.

Specifically, a control unit is arranged in the power module 107. The control unit is connected with the detection module 109 so as to receive the detection signal sent thereby. The control unit is connected with the first light-emitting portion 202 and the second light-emitting portion 105 respectively so as to control the working states of the first light-emitting portion 202 and the second light-emitting portion 105 according to the detection signal of the detection module 109. Specifically, the detection module 109 is an infrared detection module 109. The detection module 109 is arranged at a central position of the top cover 103.

The above is only the preferred implementation mode of the invention. It is to be pointed out that those of ordinary skill in the art may further make a plurality of improvements and embellishments without departing from the technical principle of the invention, and these improvements and embellishments shall also fall within the scope of protection of the invention.

1. A folding lamp, comprising a main body (1) and a plurality of light-emitting lamp bodies (2), wherein the main body (1) is provided with a plurality of first rotational connecting portions (101) around a central axis thereof; each of the light-emitting lamp bodies (2) is provided with a second rotational connecting portion (201) matched with the first rotational connecting portion (101); each of the light-emitting lamp bodies (2) is arranged rotationally on the main body (1) by means of mating of the second rotational connecting portion (201) and the corresponding first rotational connecting portion (101) such that each of the light-emitting lamp bodies (2) is endowed with a rotationally unfolded state and a folded state relative to the main body (1); and
when each of the light-emitting lamp bodies (2) is in the folded state, a first outgoing surface (2021) of a first light-emitting portion (202) in each of the light-emitting lamp bodies (2) faces an outer side, and an end face of each of the light-emitting lamp bodies (2) facing the outer side is a plane, wherein in a direction of a rotating shaft of each of the light-emitting lamp bodies (2), the first rotational connecting portion (101) comprises rotating protrusions (1011) arranged at two sides of the second rotational connecting portion (201); the rotating protrusion (1011) is provided with a first rotational mating hole (1011a); the second rotational connecting portion (201) is provided with a second rotational mating hole (2011); and the second rotational mating hole (2011) is formed coaxial with the first rotational mating hole (1011a).

2. (canceled)

3. The folding lamp according to claim 1, wherein the main body (1) comprises a base (102), a top cover (103), and a connecting pillar (104) configured to connect the base (102) with the top cover (103); the plurality of first rotational connecting portions (101) are arranged around the top cover (103); and the light-emitting lamp bodies (2) are arranged around the top cover (103), and are provided with the second rotational connecting portions (201) at ends facing the top cover (103).

4. The folding lamp according to claim 3, wherein the main body (1) is provided with a second light-emitting portion (105) on an end face that the central axis of the main body penetrates through, and a second outgoing surface (1051) of the second light-emitting portion (105) faces the outer side.

5. The folding lamp according to claim 4, wherein a plurality of second outgoing surfaces (1051) are arranged around the central axis of the main body (1) on a plane where the second outgoing surface (1051) is located;
the second outgoing surfaces (1051) are matched in number and in one-to-one correspondence with all of the light-emitting lamp bodies (2); and when each of the light-emitting lamp bodies (2) is in the rotationally unfolded state, a connecting line of a single light-emitting lamp body (2) and the corresponding second outgoing surface (1051) passes through the central axis of the main body (1).

6. The folding lamp according to claim 1, wherein the first light-emitting portion (202) comprises a first lamp panel (2022), a mounting portion (2023), and a light-transmitting plate (2024) capable of transmitting light; the mounting portion (2023) is provided with a mounting groove (2023a); the light-transmitting plate (2024) is matched with an opening of the mounting groove (2023a); a first LED lamp (2022a) is arranged on the first lamp panel (2022) in a space enclosed by the mounting groove (2023a) and the light-transmitting plate (2024); and a side of the first lamp panel (2022) where the first LED lamp (2022a) is arranged faces the light-transmitting plate (2024).

7. The folding lamp according to claim 1, wherein the first light-emitting portion (202) is arranged at a middle position of each of the light-emitting lamp bodies (2), and each of the light-emitting lamp bodies (2) is provided with a plurality of through holes (203) around the first light-emitting portion (202).

8. The folding lamp according to claim 1, wherein the main body (1) comprises a connecting piece (106) configured to obtain electric energy and a power module (107) connected with the connecting piece (106); the main body (1) is provided with a first wire hole (108) at a position where the first rotational connecting portion (101) is arranged; each of the light-emitting lamp bodies (2) is provided with a second wire hole (204) at a position where the second rotational connecting portion (201) is arranged; and a wire passes through the first wire hole (108) and the second wire hole (204) to connect the power module (107) with the first light-emitting portion (202) of each of the light-emitting lamp bodies (2).

9. The folding lamp according to claim 1, comprising four light-emitting lamp bodies (2); and
when any of the light-emitting lamp bodies (2) is in the folded state, end faces of two adjacent light-emitting lamp bodies (2) facing the outer side are perpendicular to each other.

10. The folding lamp according to claim 8, wherein a detection module (109) is arranged on the main body (1); and the detection module (109) is configured to detect whether any person is in a detection region thereof, and send a detection signal to control a working state of the first light-emitting portion (202) in each of the light-emitting lamp bodies (2).
